(19) United States
(12) Patent Application Publication
(10) Pub. No.: US 2016/0215616 A1
(43) Pub. Date: Jul. 28, 2016

(54) Estimation of Skin Effect From Multiple Depth of Investigation Well Logs

(71) Applicant: SCHLUMBERGER TECHNOLOGY CORPORATION, Sugar Land, TX (US)

(72) Inventor: Chanh Cao Minh, Katy, TX (US)

(21) Appl. No.: 15/025,482

(22) PCT Filed: Sep. 29, 2014
(86) PCT No.: PCT/US2014/057983

§ 371 Date: Mar. 28, 2016

Related U.S. Application Data
(60) Provisional application No. 61/884,002, filed on Sep. 28, 2013.

(51) Int. Cl. E21B 49/00; G01V 3/32; G01V 5/04

(52) U.S. Cl. CPC E21B 49/00; G01V 5/04; G01V 3/32

(57) ABSTRACT

A method includes obtaining measurements of a formation parameter prior to and after treatment of at least one formation penetrated a wellbore formed in the subsurface formation. The measurement correspond to a plurality of lateral depths of investigation. A difference is determined at each depth of investigation between the measurements made prior to and after the treatment. A skin effect is determined for each depth of investigation.

### CROSS-REFERENCE TO RELATED APPLICATIONS

This application claims priority to U.S. Provisional Patent Application Ser. No. 61/884002, which was filed on Sep. 28, 2013. The entirety of this provisional application is incorporated herein by reference.

### BACKGROUND

The present disclosure relates generally to the evaluation of subsurface formation productivity. More specifically, the disclosure relates to techniques for determining the “skin effect” of a formation proximate a wellbore using multiple depth of investigation (MDOI) logs.

This section is intended to introduce the reader to art that may be related to various aspects of the subject matter described and/or claimed below. This section is believed to be helpful in providing the reader with background information to facilitate a better understanding of the various aspects of the present disclosure. Accordingly, it should be understood that these statements are to be read in this light, not as admissions of prior art.

Well logging instruments have long been used in wellbores to make, for example, formation evaluation measurements to infer properties of the formations surrounding the wellbore and the fluids in the formations. Examples of well logging instruments include electromagnetic tools, nuclear tools, acoustic tools, and nuclear magnetic resonance (NMR) tools, though various other types of tools for evaluating formation properties are also available. Early logging tools were inserted into and moved along the interior of a wellbore on an armored electrical cable after the wellbore had been drilled. Modern versions of such wireline tools are still used extensively. However, as the demand for information while drilling a welbore continued to increase, measurement-while-drilling (MWD) tools and logging-while-drilling (LWD) tools have since been developed. MWD tools typically provide drilling parameter information such as weight on the bit, torque, temperature, pressure, geodetic or geomagnetic wellbore direction, and wellbore inclination. LWD tools typically provide formation evaluation measurements such as resistivity, porosity, NMR distributions, among other parameters. MWD and LWD tools often have characteristics common to wireline tools (e.g., transmitting and receiving antennas, sensors, etc.), but MWD and LWD tools are designed and constructed to endure and operate in the harsh environment of drilling.

Wellbores are drilled through subsurface rock formations to extract useful substances such as hydrocarbons in the form of oil and gas. For example, a wellbore forms a hydraulic conduit from a permeable subsurface rock formation having oil and/or gas present therein to the Earth's surface. Oil and/or gas typically move to the surface through the wellbore by gravity. Gravity manifests itself as a pressure drop between the fluid pressure in the pore spaces of the subsurface rock formation and the wellbore. The rate at which the oil and/or gas move into the wellbore and to the surface depend on the pressure drop between the formation and the wellbore, the viscosity of the oil and/or gas, and the effective permeability of the rock formation to the oil and/or gas (referred to as the “mobility” of the oil and/or gas).

As is known in the art, the permeability of a rock formation can be affected by the process of drilling a wellbore therethrough. Such effects can result from migration of small particles in the drilling fluid (also called drilling “mud”) used to drill the wellbore, reaction of certain formation minerals (e.g., clay minerals such as kaolinite and chlorite) disposed in the pore spaces with the liquid phase of the drilling mud, and/or mechanical and chemical alteration of the formation by the action of drilling the wellbore. One typical effect is that the permeability of the rock formation proximate the wellbore is reduced. Such near-wellbore permeability reduction is often referred to as a “skin effect” (or “skin damage” or “skin factor” or the like) and may result in lower oil and/or gas flow rates than would be expected for the particular rock formation and/or the existing pressure drop from the formation to the wellbore.

For certain formation evaluation procedures, for example, formation fluid testing using instruments conveyed into the wellbore, the existence of skin damage may result in test failure or a false indication that a particular formation is not likely to be productive of oil and/or gas. The existence of skin damage may be confirmed by more extensive testing of the formation, and remedial operations can be performed to reduce any production rate loss resulting from skin damage. However, it would be advantageous to evaluate possible skin damage quickly and efficiently so as to reduce the number of formations improperly identified as non-productive, to reduce the number of formation tests that are failure prone, and to better and more efficiently identify subsurface formations that may benefit from remedial operations to correct skin damage.

### SUMMARY

A summary of certain embodiments disclosed herein is set forth below. It should be understood that these aspects are presented merely to provide the reader with a brief summary of certain embodiments and that these aspects are not intended to limit the scope of this disclosure. Indeed, this disclosure may encompass a variety of aspects that may not be set forth in this section.

A method is disclosed which includes obtaining measurements of a formation parameter prior to and after treatment of at least one formation penetrated by a wellbore formed in the subsurface formation, the measurement corresponding to a plurality of lateral depths of investigation. The method further includes determining a difference between the measurements made prior to and after the treatment at each depth of investigation and determining a skin effect for each depth of investigation.

A system includes a well logging instrument having sensors for measuring at least one parameter of formations surrounding a wellbore at different lateral depths in the formation from a wall of the wellbore, means for recording measurements made by the well logging instrument, means for comparing recorded measurements made prior to application of a treatment to a selected formation in the wellbore to measurements made after the application of the treatment, and means for determining skin effect at different lateral depths from the compared measurements.

Again, the brief summary presented above is intended to familiarize the reader with certain aspects and contexts of embodiments of the present disclosure without limitation to the claimed subject matter.

### BRIEF DESCRIPTION OF DRAWINGS

FIG. 1 is an example of a well logging instrument moved through a wellbore drilled through a subsurface rock formation.

FIG. 2 is an example of a well system where a borehole is formed in a subsurface rock formation using logging-while-drilling tools.

FIG. 3 is a graph that shows the relationship between permeability and porosity.

FIG. 4 shows a radial pressure profile of a subsurface reservoir in the presence and in the absence of skin damage.

FIG. 5 is a plot showing a two dimensional acid radial distribution.

FIG. 6 shows an example display in the form of tracks showing ΔΣ_{acid} log measurements at different DOIs, changes in borehole diameter pre- and post-acid treatment, skin effect at each DOI, and a radial acid map.

FIG. 7 shows examples of different scenarios that may be encountered with MDOI ΔΣ_{acid} measurements.

### DETAILED DESCRIPTION

One or more specific embodiments according to the present disclosure are described below. These embodiments are merely examples of the presently disclosed techniques. Additionally, in an effort to provide a concise description of these embodiments, all features of an actual implementation may not be described herein. It should be appreciated that in the development of any such implementation, as in any engineering or design project, numerous implementation-specific decisions are made to achieve the developers' specific goals, such as compliance with system-related and business-related constraints, which may vary from one implementation to another. Moreover, it should be appreciated that such development efforts might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The embodiments discussed below are intended to be examples that are illustrative in nature and should not be construed to mean that the specific embodiments described herein are necessarily preferential in nature. Additionally, it should be understood that references to “one embodiment” or “an embodiment” within the present disclosure are not to be interpreted as excluding the existence of additional embodiments that also incorporate the recited features.

Aspects of the present disclosure relate to techniques for determining formation skin damage using multiple depths of investigation (MDOI) well logs. Additional aspects of the present disclosure also relate to formation skin effect reduction techniques, such as acid treatment of a formation. U.S. Pat. No. 7,675,287 (hereinafter the '287 patent) discloses one example of a method for estimating skin damage of a subsurface formation using nuclear magnetic resonance (NMR) measurements made at multiple lateral depths into the formation from the wall of the wellbore. Embodiments set forth herein will describe methods for determining skin effect using MDOI measurements other than NMR.

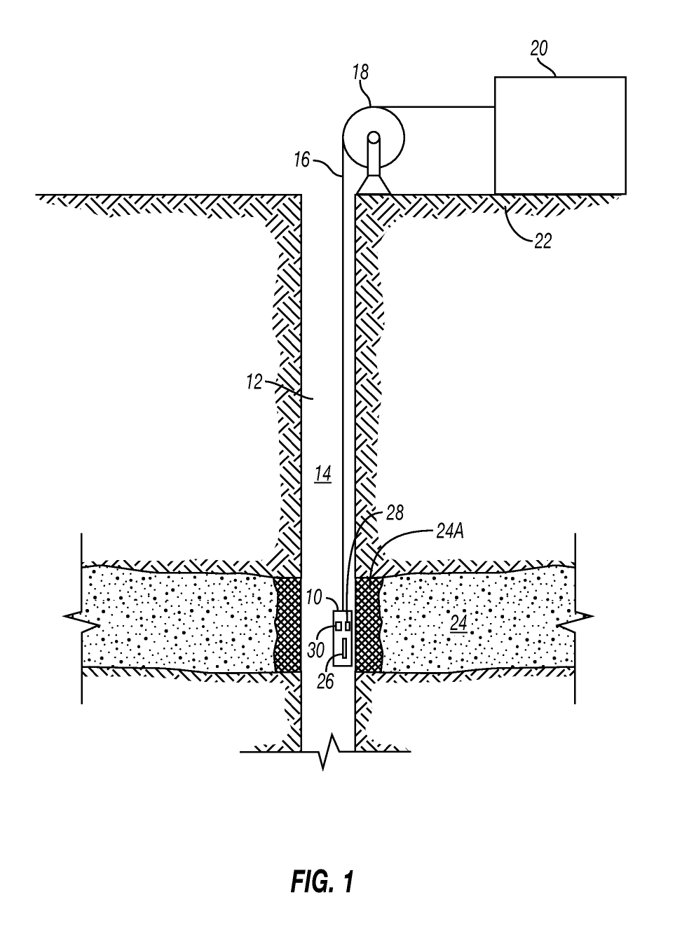

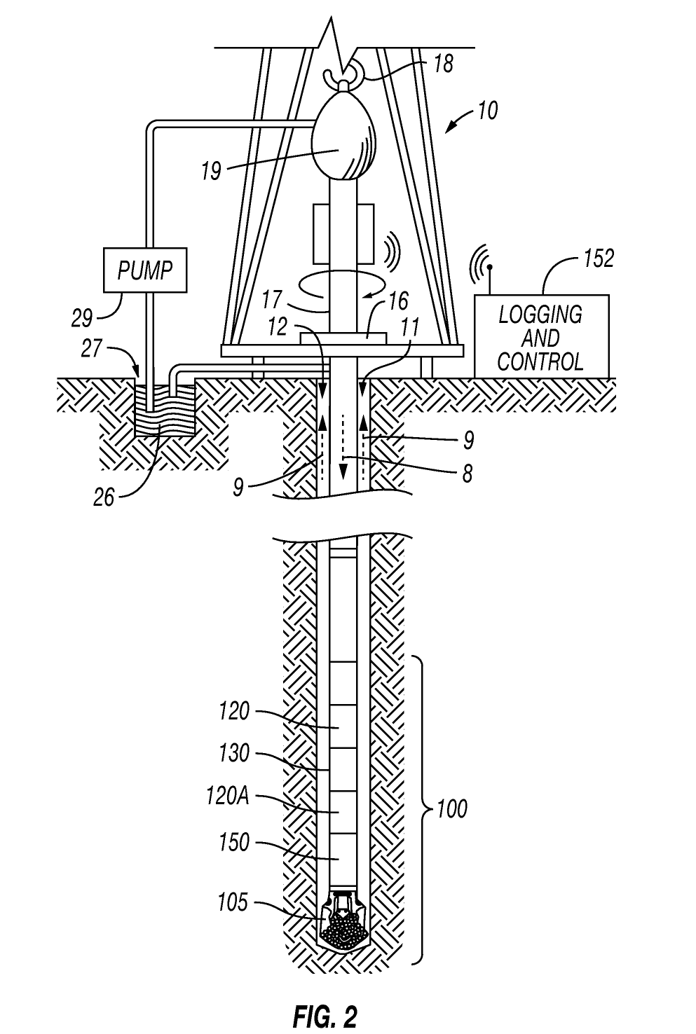

FIG. 1 shows an example of a well logging instrument 10 being moved along a wellbore 12 drilled through subsurface rock formations 22, including one or more permeable rock formations 24. The instrument 10 may be moved along the interior of the wellbore 12 at the end of an armored electrical cable 16 (“wireline”) deployed by a winch 18 or similar device known in the art. The instrument 10 may be in signal communication with a surface deployed “recording unit” 20 that may include systems (not shown separately for clarity of the illustration) for providing electrical power to operate the instrument 10, to receive and decode signals from the instrument 10 and to make a recording, indexed with respect to depth of the instrument in the wellbore or indexed with respect to time, of the signals transmitted from the instrument 10 to the recording unit 20. The recording unit 20 may contain certain processors and computer equipment as will be further explained with reference to FIG. 2.

As explained in the Background section herein, the wellbore 12 may include drilling mud 14 or similar fluid used during the drilling of the wellbore 12. In certain cases, the drilling mud 14 may interact with certain permeable formations (e.g., formation 24) so as to affect permeability of the formation proximate the wellbore. Such permeability-affected zone is indicated as a “damaged zone” at 24A and may have lower permeability than the remainder of the formation 24 laterally more distant from the wellbore 12. In methods according to the present disclosure, measurements made by the well logging instrument 10 may be used to determine formation permeability at several different lateral distances from the wellbore wall into the formation 24, and such determinations may be used to estimate the amount of skin effect.

As an example only, the well logging instrument 10 in FIG. 1 may be a nuclear magnetic resonance (NMR) logging tool. In other embodiments, the instrument 10 may include a nuclear logging tool, an electromagnetic resistivity logging tool, or any other suitable type of logging tool that is capable of measuring one or more parameters indicative of formation characteristics. Assuming an NMR logging tool (as is described in the '287 patent), the well logging instrument 10 may be configured to make NMR measurements, and may include a magnet 26 to prepolarize susceptible atomic nuclei in the formation 24, typically hydrogen, along the direction of the magnetic field induced by the magnet 26. The instrument 10 may include one or more radio frequency (“RF”) antennas 28 coupled to suitable energizing and detecting circuitry 30 to induce NMR phenomena in the formation 24 and to detect NMR phenomena from within the formation 24. The detected NMR phenomena can be used to determine, for example, permeability of the formation at a plurality of lateral distances from the wellbore wall. An example of such an NMR logging tool can include those available under the trademarks MR SCANNER and PROVISION, which are trademarks of Schlumberger Technology Corporation, Sugar Land, Tex. In another embodiment, the instrument 10 may be a nuclear logging tool configured to acquire various nuclear measurements, such as thermal neutron capture cross-section (Sigma), natural gamma-ray measurements, bulk density measurements, and/or neutron porosity measurements. An example of such an instrument is available under the trademark ECOSCOPE, which is also a trademark of Schlumberger Technology Corporation.

While wireline deployment is shown in FIG. 1, it is to be clearly understood that such deployment is only an example of possible deployment of an instrument that may be used in accordance with the present disclosure. Other deployment methods that may be used include, without limitation, deployment in or on a string of drill pipe, on a coiled tubing, at the end of “slickline” (single, solid strand wire or cable), in or on a production tubing, casing or other tubular device known in the art. Such deployment may be made while the wellbore 12 is being drilled (logging-while-drilling) or thereafter (logging-while-tripping or other conveyances including wireline and slickline). FIG. 2 shows an example of a logging-while-drilling (LWD) system.

As shown, FIG. 2 represents a simplified view of a well site system in which various embodiments can be used. The well site system depicted in FIG. 2 can be deployed in either onshore or offshore applications. In a system as shown in FIG. 2, a wellbore 11 is formed in subsurface formations by rotary drilling in a manner that is well known to those skilled in the art. Although the wellbore 11 in FIG. 2 is shown as being drilled substantially straight and vertically, some embodiments may be directionally drilled.

A drill string 12 is suspended within the borehole 11 and has a bottom hole assembly (BHA) 100 which includes a drill bit 105 at its lower end. The surface system includes a platform and derrick assembly 10 positioned over the borehole 11, with the assembly 10 including a rotary table 16, kelly 17, hook 18 and rotary swivel 19. In a drilling operation, the drill string 12 is rotated by the rotary table 16 (energized by means not shown), which engages the kelly 17 at the upper end of the drill string. The drill string 12 is suspended from a hook 18, attached to a traveling block (also not shown), through the kelly 17 and a rotary swivel 19 which permits rotation of the drill string 12 relative to the hook 18. As is well known, a top drive system could be used in other embodiments.

Drilling fluid or mud 26 may be stored in a pit 27 formed at the well site. A pump 29 delivers the drilling fluid 26 to the interior of the drill string 12 via a port in the swivel 19, which causes the drilling fluid 26 to flow downwardly through the drill string 12, as indicated by the directional arrow 8 in FIG. 2. The drilling fluid exits the drill string 12 via ports in the drill bit 105, and then circulates upwardly through the annulus region between the outside of the drill string 12 and the wall of the borehole, as indicated by the directional arrows 9. In this known manner, the drilling fluid lubricates the drill bit 105 and carries formation cuttings up to the surface as it is returned to the pit 27 for recirculation.

The drill string 12 includes a BHA 100. In the illustrated embodiment, the BHA 100 is shown as having one MWD module 130 and multiple LWD modules 120 (with reference number 120A depicting a second LWD module 120). As used herein, the term “module” as applied to MWD and LWD devices is understood to mean either a single tool or a suite of multiple tools contained in a single modular device. Additionally, the BHA 100 includes a rotary steerable system (RSS) and motor 150 and a drill bit 105.

The LWD modules 120 may be housed in a drill collar and can include one or more types of logging tools. The LWD modules 120 may include capabilities for measuring, processing, and storing information, as well as for communicating with the surface equipment. By way of example, the LWD module 120 may include one of a nuclear magnetic resonance (NMR) logging tool, a nuclear logging tool, a resistivity logging tool, an acoustic logging tool, or a dielectric logging tool, and so forth, and may include capabilities for measuring, processing, and storing information, and for communicating with surface equipment.

The MWD module 130 is also housed in a drill collar, and can contain one or more devices for measuring characteristics of the drill string and drill bit. In the present embodiment, the MWD module 130 can include one or more of the following types of measuring devices: a weight-on-bit measuring device, a torque measuring device, a vibration measuring device, a shock measuring device, a stick/slip measuring device, a direction measuring device, and an inclination measuring device (the latter two sometimes being referred to collectively as a D&I package). The MWD tool 130 further includes an apparatus (not shown) for generating electrical power for the downhole system. For instance, power generated by the MWD tool 130 may be used to power the MWD tool 130 and the LWD tool(s) 120. In some embodiments, this apparatus may include a mud turbine generator powered by the flow of the drilling fluid 26. It is understood, however, that other power and/or battery systems may be employed.

The operation of the instrument 10 of FIG. 2 may be controlled using a control system 152 located at the surface. The control system 152 may include one or more processor-based computing systems. In the present context, a processor may include a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for instance, workflows and the like for carrying out a drilling operation, algorithms and routines for processing data received at the surface from the BHA 100 (e.g., as part of an inversion to obtain one or more desired formation parameters), and so forth. The processor-based computing systems in the control system 152 may be substantially similar to those contained in the recording unit (20 in FIG. 1).

With reference again to the '287 patent, NMR measurements at multiple depths of investigation can be used to estimate permeability. For example, at each longitudinal position (depth) in the wellbore at which measurements are made by the instrument 10, a set of NMR measurements and a corresponding set of permeability values may be determined. As an example, for the MR SCANNER well logging instrument, NMR measurements may be made at lateral depths of approximately 1.5 inches (38 mm), 2.7 inches (68 mm) and 4 inches (101 mm) into the formation from the wall of the wellbore. In one example, undamaged permeability may be extrapolated from the permeability measurements made at each DOI by the foregoing NMR well logging instrument, or by deriving porosity from the NMR measurements. The determined permeability values may be used to estimate the skin factor as will be explained below.

Skin factor (S) may be represented by the following expression;

S=(K/Kₛ−1)ln(rₛ/r_{w}) (1)

wherein K is the undamaged formation horizontal permeability, Kₛ is the damaged zone horizontal permeability, rₛ is the radius of the damaged zone from the center of the wellbore, and r_{w} is the radius of the wellbore.

Permeability may be expressed as follows:

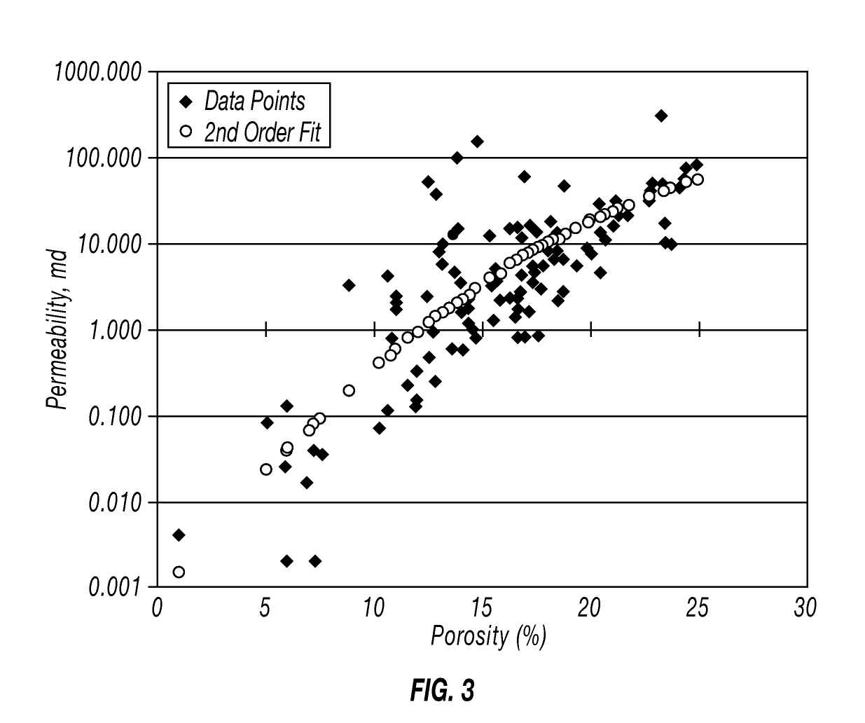

ln K=aφ+b (2)

where φ is porosity and a and b are coefficients which may be determined, in one example, from a crossplot of measured formation sample (core) permeability with respect to porosity. FIG. 3 illustrates an example relationship between permeability (in logarithmic scale) and porosity.

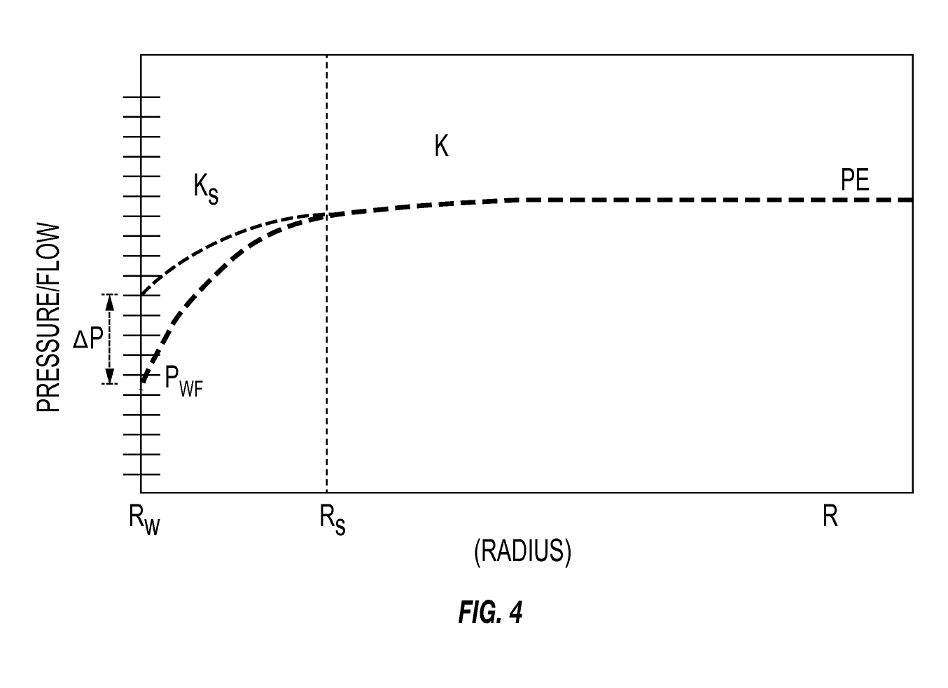

How skin effect affects pressure drop with respect to flow rate can be observed in the graph of FIG. 4. As can be observed in FIG. 4, at a relatively large distance from the wellbore (indicated on the coordinate axis at R) the pressure in the subsurface formation is essentially unaffected by pressure drop caused by fluid flowing into the wellbore. At closer distances to the wellbore, the formation fluid pressure will drop by an amount depending on the flow rate and the permeability of the formation. The solid line of the graph extending toward the radius of the wellbore R_{w} indicates the flowing pressure profile in the presence of skin damage, wherein the skin damage extends to a radius into the formation indicated by Rₛ. The pressure or flow rate, indicated on the ordinate axis of FIG. 4, shows that the flowing pressure in the wellbore P_{wf} is typically substantially lower than the corresponding pressure and flow rate in the absence of skin damage, shown by the dashed curve section of the graph terminating at a pressure value of P_{wf}+ΔPₛₖᵢₙ. Permeability values K and Kₛ for the undamaged and skin damaged formation, respectively, are shown in their lateral positions in the graph in FIG. 4.

The concept of pseudo-wellbore radius, r′_{w} caused by skin effect may be represented by the expression:

r′_{w}=r_{w}e^{-s} (3)

Thus, after computing S for the shallower DOI measurements (whether it is NMR or another type of measurement), the above equation can be used to estimate r′_{w}. Skin factor for successively larger DOI measurements can then be calculated by substituting r_{w} in equation (1) with r′_{w} determined from equation (3). The foregoing may be repeated for each set of successively larger DOI measurements.

Referring again to Equations (1) and (2), it may be observed that knowledge of porosity (which can be expressed as a function of permeability) can enable estimating skin effect. For example, in substituting Equation 2 into Equation 1, the following expression may be derived:

S=(e^{a(φ-φ}^{ₛ}⁾−1)ln(rₛ/r_{w}) (4)

where φ represents the unaltered zone porosity and φₛ represents the altered zone porosity.

By expanding the exponential term in Equation 4 (e.g., using Taylor series expansion) while keeping the first term enables S to be expressed as:

S=a(φ−φₛ+ . . . )ln(rₛ/r_{w}) (5)

Because the term ln(rₛ/r_{w}) is always positive, the sign of the skin effect S will be a function of the difference between the unaltered zone porosity (φ) and the altered zone porosity (φₛ). Thus, S is greater than 0 when (φ−100 ₛ)>0(indicating a damaged formation with reduced porosity in the damaged zone), and S is less than 0 when (φ−φₛ)<0 (indicating a stimulated formation, i.e., acid treatment increasing the porosity in the stimulated zone). As can be appreciated, an “acid job” refers to the treatment of a reservoir formation with a stimulation fluid, typically containing a reactive acid. The acid may react with soluble substances in the formation to enlarge pore spaces, or may dissolve parts of the formation matrix. Thus, in wells where skin damage is a problem, treating the well with acid may reduce the effect of skin damage and increase formation productivity.

In accordance with embodiments of the present technique, porosities can be estimated or otherwise determined from one or more of the following multiple DOI types of measurements: density, neutron, dielectric, resistivity (including micro-resistivity), thermal neutron capture cross-section (Sigma) or NMR.

The radius of the altered zone (whether damaged or stimulated) may be be estimated using near-wellbore MDOI logs. For instance, commonly assigned U.S. Pat. No. 8,521,435 (entitled “Estimating Sigma Log Beyond the Measurement Points”) describes example techniques for acquiring multiple DOI Sigma measurements. Specifically, the techniques described in the '435 patent relate to methods to determine the thermal neutron capture cross-section of a subsurface formation at a desired lateral depth in the formation. In accordance with an embodiment, a database of Sigma values for known lithologies, porosities, and salinities is provided, and multiple Sigma measurements are obtained from a downhole logging tool. Within the database, Sigma values are interpolated to determine the respective depths of investigation of the multiple Sigma measurements. A monotonic function is fitted to the multiple Sigma measurements at the determined depths of investigation, and the capture cross-section of the subsurface formation at any desired depth in the formation is determined using the fitted function. Also, porosities may be determined at multiple DOIs using the techniques described in the '435 patent, which may then be used to estimate skin effect, as described above. In another example, radius of the altered zone can be determined using conventional resistivity diameter of invasion estimation from multiple DOI micro-resistivity logs.

Recent advances in LWD pulsed neutron MDOI array sigma logs have enabled the computation of three ΔΣ_{acid} logs (sigma difference logs pre- and post-acid treatment) from the shallow, medium and deep array of the pre-acid and post-acid well log measurements, respectively, as described in Mauborgne et al., Advances In LWD Multiple Depth of Investigation Array Sigma Measurements, SPWLA 54th Annual Logging Symposium (2013).

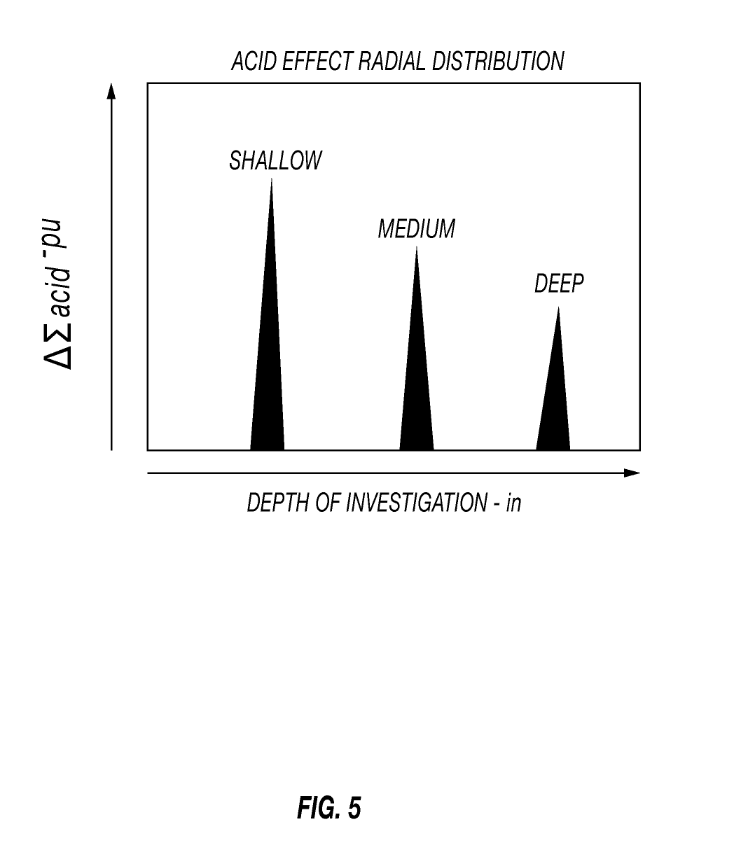

Displaying the three ΔΣ_{acid} logs with respect to their variable DOI versus depth produces a two-dimensional acid radial distribution log to aid in interpretation (such logs may resemble NMR T2 distribution logs), as shown in FIG. 5. In one embodiment, the mean, minimum, and maximum acid penetration depths can be determined by taking various weighted averages of the acid distribution log. Since the increase of formation productivity after an acid job may be measured by ΔΣ_{acid} and the pre-acid and post-acid drilling fluid salinity may be expected to be similar, it can be shown that:

$$φ = \frac{{Σ}_{m} - Σ}{{Σ}_{m} - {Σ}_{f}} \\ Δ {Σ}_{acid} = c Δ φ + d \qquad ( 6 )$$

Where the suffix m denotes the matrix and f denotes the fluid.

Thus, the skin effect for the shallow, medium, and deep array Sigma can be estimated respectively based on Equation 4 as follows:

S=−(e^{cΔΣ}^{_{acid}}^{+d}−1)ln(rₛ/r_{w}) (7)

where rₛ=r_{w}+DOI for each radial Sigma measurement. For instance, the DOI may be estimated using a MDOI Sigma inversion as described in the '435 patent.

The coefficients c and d may be determined from the expressions:

ln(k_{post-acid}/k_{pre-acid})=cΔΣ_{acid}+d (7a)
1. Consider the case of no permeability increase post-acid, k_{post-acid}/k_{pre-acid}=1 when ΔΣ_{acid}=0, thus d=0.
2. Consider the case of increase in permeability, k_{post acid}/k_{pre acid}=x when ΔΣ_{acid}=y, thus, c can be determined from Eq. 7a.

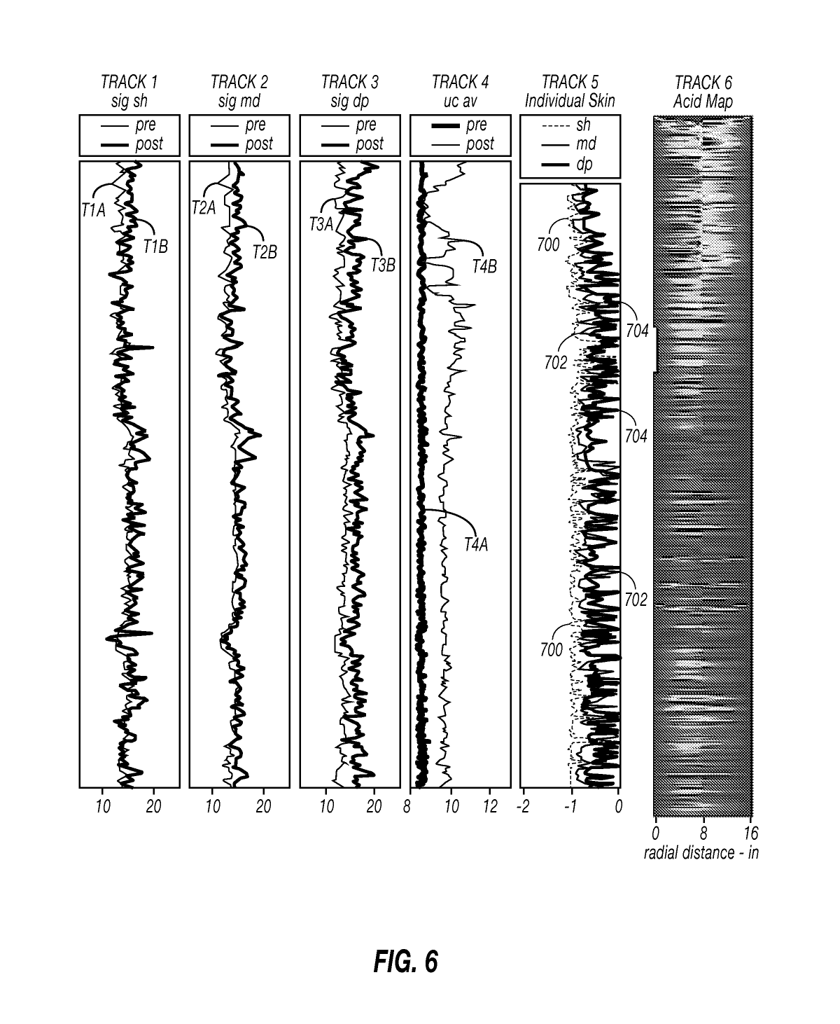

FIG. 6 shows an example well log presentation in the form of “tracks”, shown as Track 1 through Track 6. The example well log shows ΔΣ_{acid} for shallow, medium, and deep sigma measurements in Tracks 1, 2, and 3, respectively. In each of these tracks, the curve that is generally more on the left side of the track, T1A, T2A, T3A, respectively, shows the pre-acid treatment measurement. The curve generally more on the right side of the track, T1B, T2B, T3B, respectively shows the post-acid treatment measurements. Track 4 shows the borehole diameter change (e.g., measured using a caliper, i.e., an ultrasonic caliper) pre and post acid treatment at curves T4A and T4B, respectively. Track 5 displays the three skin effect values as calculated using Equation (7) for the shallow measurement at curve 700, the medium depth measurement at curve 702, and the deep measurement at curve 704. For the foregoing curves, a=1 for purposes of solution of Equation (7). Track 6 displays a radial acid map showing in gray scale (or color if desired) effective penetration of the acid treatment at each depth determined from the log measurements.

The increase in the productivity index PI is directly proportional to a negative change in skin effect value and may be determined using the following equations:

ΔP=142.2(qμBo/Kh)S (8a)

PI=0.00708 Kh/(μBo ln(rₑ/r_{w})+S) (8b)

### Where:

ΔP is the skin excess pressure drawdown (in psi)
PI is the productivity index
q is flow rate in stb/d (stock tank barrels per day)
μ is viscosity in centipoises
Bo is the oil formation volume factor (stock tank barrels per reservoir barrel)
S is the dimensionless skin factor
K is permeability in and (darcies)
h is thickness in feet
rₑ is the effective drainage radius in feet

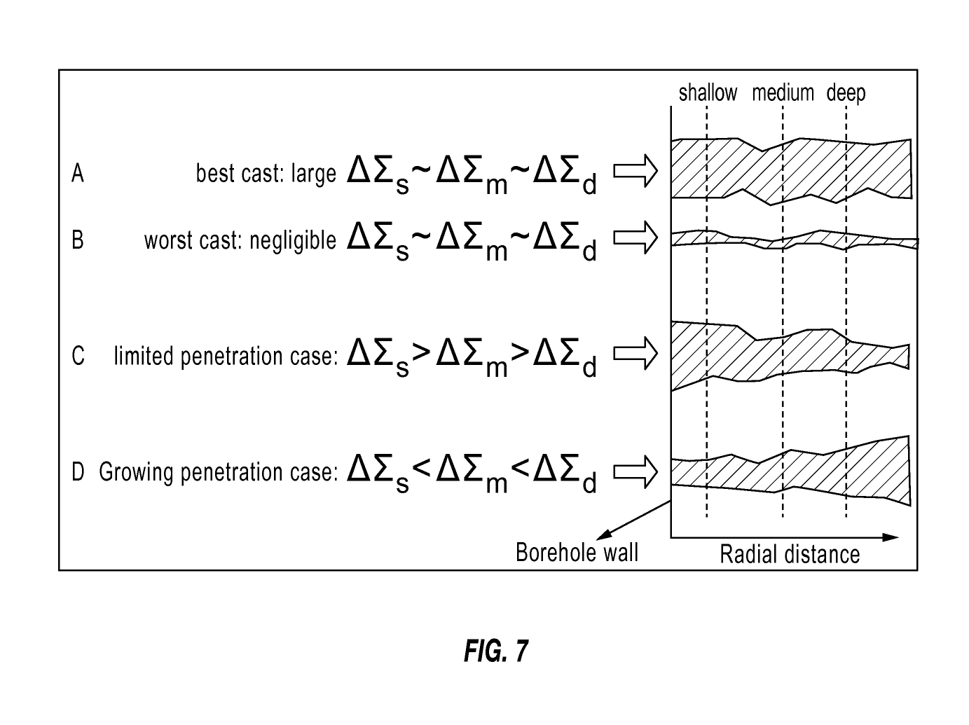

In accordance with the present disclosure, the formation productivity radial variation may be visualized as an enlargement of the flow path measured by MDOI ΔΣ_{acid} measurements. This is shown in FIG. 7 which essentially provides an example interpretation of MDOI ΔΣ_{acid} measurements. Here, the flow path area is illustrated by the shaded area in some possible scenarios. In scenario A, the ΔΣ measurements are generally large for each of the shallow, medium, and deep DOIs, and thus provides a large flow path area across the DOIs. In scenario B, ΔΣ measurements correspond to small flow path area for each of the shallow, medium, and deep DOIs. Scenario C shows an example where the flow path area decreases further into the formation. Scenario D shows an example where the flow path area increases further into the formation. Other scenarios may be a combination of two or more the four cases shown in FIG. 7.

Methods according to the present disclosure may enable estimating skin factor for a plurality of different formations penetrated by a wellbore using only a single well logging run, thus saving substantial time and cost. By estimating skin factor beforehand, it may be possible to select particular formations for fluid and/or pressure transient testing, such as by wireline formation testing instrument, that are more likely to be successfully tested. Such may avoid the expense and lost time of testing formations more susceptible to flow and/or pressure test failure. It may be possible to identify possibly hydrocarbon productive formations that would benefit by remedial operations to overcome skin effect, such as by hydraulic fracturing or acid treatment.

In this disclosure, the use of time-lapse well logs, for example, thermal neutron capture cross section (sigma) logging to identify pre-treatment and post-treatment sigma differences, ΔΣ, is applied to pre-treatment and post-treatment multiple depth of investigation (MDOI) measurements to analyze treatment effectiveness. In some embodiments, such analysis may be peformed in an extended reach horizontal well drilled in a carbonate reservoir.

Many extended reach horizontal wells may be stimulated to enhance productivity. Acid treatment is an example technique used to stimulate carbonate formations. Recent advances in LWD pulsed-neutron MDOI array sigma measurements may provide three ΔΣ_{acid} (pre- and post-acid treatment) logs from shallow, medium and deep sensor array of the pre-acid and post-acid runs respectively. The present disclosure also includes the following aspects: (1) displaying the three MDOI difference magnitudes with respect to their variable DOI versus depth to produce a 2D treatment (e.g., acid) distribution log that resembles NMR T2 distribution logs; (2) determining mean, minimum and maximum treatment penetration depths by taking various weighted averages of the treatment distribution log; and (3) when ΔΣ_{acid} indicates a positive change in permeability, using Hawkin's damage zone computation from reservoir engineering literature to compute recursively a continuous skin effect curve. Values of skin effect may be negative in the case of effective treatment. In essence, the disclosure discusses the advantages of both the time dimension and the radial dimension of MDOI well logging to advance the understanding and evaluation of the effectiveness of formation treatment of damaged zones by evaluating changes in skin effect.

As will be understood by those skilled in the art, the various techniques described above and relating to estimation of skin damage in a formation are provided as example embodiments. Accordingly, it should be understood that the present disclosure should not be construed as being limited to only the examples provided above. Further, it should be appreciated that the techniques disclosed herein may be implemented in any suitable manner, including hardware (suitably configured circuitry), software (e.g., via a computer program including executable code stored on one or more tangible computer readable medium), or via using a combination of both hardware and software elements. Further, it is understood that the various techniques described may be implemented on a downhole processor (e.g., a processor that is part of a logging tool), with the results sent to the surface by any suitable telemetry technique. Additionally, in other embodiments, measurements may be transmitted uphole via telemetry and the determination of skin damage may be performed uphole on a surface computer (e.g., part of control system 152 in FIG. 2).

While the specific embodiments described above have been shown by way of example, it will be appreciated that many modifications and other embodiments will come to the mind of one skilled in the art having the benefit of the foregoing description and the associated drawings. Accordingly, it is understood that various modifications and embodiments are intended to be included within the scope of the appended claims.

What is claimed is:

1. A method comprising:
obtaining measurements of a formation parameter prior to and after treatment of at least one formation penetrated by a wellbore formed in the subsurface formation, the measurement corresponding to a plurality of lateral depths of investigation;
at each depth of investigation, determining a difference between the measurements made prior to and after the treatment; and
determining a skin effect for each depth of investigation.

2. The method of claim 1, wherein the plurality of depths of investigation comprises at least three depths of investigation.

3. The method of claim 2, wherein the measurements comprise thermal neutron capture cross-section (sigma) measurements.

4. The method of claim 3, further comprising displaying the three sigma differences with respect to depth of investigation versus depth to produce a two-dimensional treatment distribution log.

5. The method of claim 4, comprising determining mean, minimum, and maximum penetration depths based on weighted averages of the treatment distribution log.

6. The method of claim 3, wherein the measurements comprise pulsed neutron logging measurements.

7. The method of claim 1 wherein the measurements comprise nuclear magnetic resonance measurements.

8. The method of claim 1, wherein the measurements are made using at least one of a wireline conveyed instrument, a logging-while-drilling instrument, and a slickline logging instrument.

9. The method of claim 1 wherein the treatment comprises acid treatment.

10. The method of claim 1, wherein the skin effect (S) at each depth of investigation is determined according to: S=(e^{a(φ-φ}^{ₛ}⁾−1)ln(rₛ/r_{w}), where φ represents the unaltered zone porosity, φₛ represents the altered zone porosity, rₛ is the radius of a damaged zone from the center of the wellbore, and r_{w} is the radius of the wellbore.

11. The method of claim 10, wherein (φ−φₛ)>0 indicates a skin damaged formation with reduced porosity in the damaged zone and wherein (φ−φₛ)<0 indicates a treated formation with increased porosity in a stimulated zone.

12. A system, comprising:
a well logging instrument having sensors for measuring at least one parameter of formations surrounding a wellbore at different lateral depths in the formation from a wall of the wellbore;
means for recording measurements made by the well logging instrument;
means for comparing recorded measurements made prior to application of a treatment to a selected formation in the wellbore to measurements made after the application of the treatment; and
means for determining skin effect at different lateral depths from the compared measurements.

13. The system of claim 12 wherein the well logging instrument comprises a nuclear magnetic resonance measurement instrument.

14. The system of claim 12 wherein the well logging instrument comprises a thermal neutron capturer cross section measurement instrument.

15. The system of claim 14 wherein the thermal neutron capture cross section instrument comprises a pulsed neutron instrument.

16. The system of claim 14, further comprising means for displaying the three sigma differences with respect to depth of investigation versus depth to produce a two-dimensional treatment distribution log.

17. The system of claim 15, wherein the means for displaying comprises means for determining mean, minimum, and maximum penetration depths based on weighted averages of the treatment distribution log.

18. The system of claim 12 wherein the means for determining skin effect at each depth of investigation is configured to calculate values of skin effect (S) as: S=(e^{a(φ-φ}^{ₛ}⁾−1)ln(rₛ/r_{w}), where φ represents the unaltered zone porosity, φₛ represents the altered zone porosity, rₛ is the radius of a damaged zone from the center of the wellbore, and r_{w} is the radius of the wellbore.

19. The system of claim 18, wherein the means for determining skin effect is configured to calculated when (φ−φₛ)>0 as indicating a skin damaged formation with reduced porosity in the damaged zone and when (φ−φₛ)<0 as indicating a treated formation with increased porosity in a stimulated zone.

20. The system of claim 12 wherein the well logging instrument comprises at least one of a wireline conveyed instrument, a logging-while-drilling instrument, and a slickline logging instrument.
